(19) United States
(12) Patent Application Publication
(10) Pub. No.: US 2026/0214554 A1
(43) Pub. Date: Jul. 23, 2026

(54) METHOD PERFORMED BY ACCESS NETWORK NODE, METHOD PERFORMED BY MOBILE DEVICE, ACCESS NETWORK NODE, AND MOBILE DEVICE

(71) Applicant: NEC Corporation, Tokyo (JP)

(72) Inventor: Xuelong WANG, Guildford (GB)

(73) Assignee: NEC Corporation, Tokyo (JP)

(21) Appl. No.: 19/135,901

(22) PCT Filed: Nov. 22, 2023
(86) PCT No.: PCT/JP2023/042055

§ 371 Date: Jun. 5, 2025

(30) Foreign Application Priority Data
Dec. 12, 2022 (GB) 2218671.2

(51) Int. Cl. H04W 48/14; H04W 48/12; H04W 52/02

(52) U.S. Cl. CPC H04W 48/14; H04W 48/12; H04W 52/0206

(57) ABSTRACT

The present disclosure relates to a method performed by an access network node, the method comprising: transmitting, in a first cell operated by the access network node, minimum system information associated with a second cell configured to not transmit at least the minimum system information; receiving, from a user equipment, UE, a request for another system information associated with the second cell based on the minimum system information associated with the second cell; and transmitting, to the UE in the first cell, at least a portion of the other system information.

### TECHNICAL FIELD

The present disclosure relates to a communication system. The disclosure has particular but not exclusive relevance to wireless communication systems and devices thereof operating according to the 3rd Generation Partnership Project (3GPP) standards or equivalents or derivatives thereof (including LTE-Advanced, Next Generation or 5G networks, future generations, and beyond). The disclosure has particular, although not necessarily exclusive relevance to, improved apparatus and methods for network energy saving (NES) cells.

### BACKGROUND ART

Recent developments of the 3GPP standards are referred to as the Long-Term Evolution (LTE) of Evolved Packet Core (EPC) network and Evolved UMTS Terrestrial Radio Access Network (E-UTRAN), also commonly referred as ‘4G’. In addition, the term ‘5G’ and ‘new radio’ (NR) refer to an evolving communication technology that is expected to support a variety of applications and services. Various details of 5G networks are described in, for example, the ‘NGMN 5G White Paper’ V1.0 by the Next Generation Mobile Networks (NGMN) Alliance, which document is available from https://www.ngmn.org/5g-white-paper.html. 3GPP intends to support 5G by way of the so-called 3GPP Next Generation (NextGen) radio access network (RAN) and the 3GPP NextGen core network.

Under the 3GPP standards, a NodeB (or an eNB in LTE, gNB in 5G) is the radio access network (RAN) node (or simply ‘access node’, ‘access network node’ or ‘base station’) via which communication devices (user equipment or ‘UE’) connect to a core network and communicate with other communication devices or remote servers. For simplicity, the present application will use the term RAN node or base station to refer to any such access nodes.

One method of achieving a more efficient communication network is to reduce the energy requirements needed to provide a cell. Network energy saving (NES) cells having a reduced number of broadcast transmissions may be provided. In a non-anchor NES cell, some types of transmission (e.g. some types of broadcast transmissions) may not transmitted in the cell. For example, system information corresponding to one or more system information blocks (SIB) may not be transmitted in the non-anchor NES cell. Access for a UE 3 to the non-anchor NES cell may be configured using transmissions in a corresponding anchor cell.

However, when implementing NES cells there are a number of considerations that need to be taken into account. For example, efficient and reliable mechanisms for enabling the UE 3 to obtain system information (SI) for accessing the NES cell are needed. Whilst an anchor cell corresponding to the NES cell may be provided, in which information for configuring the UE 3 to access the NES cell is transmitted, there is a problem that energy consumption may not be reduced if the anchor cell simply broadcasts the information that is not transmitted in the non-anchor NES cell (e.g. the system information blocks (SIB) that are not transmitted in the non-anchor NES cell). In other words, there is a problem that energy savings at the non-anchor NES cell are offset by additional energy expenditure at the corresponding anchor cell. Moreover, the SI may include ‘other SI’ (OSI) that is transmitted to a user equipment upon a request for the OSI from the UE 3, and efficient and reliable mechanisms for providing the OSI of a non-anchor NES cell to a UE 3 are needed.

More generally, there is a need for more efficient and reliable methods and apparatus for providing a UE 3 with information for accessing and communicating via an NES cell.

### CITATION LIST

### Non Patent Literature

NPL 1: ‘NGMN 5G White Paper’ V1.0

### SUMMARY OF INVENTION

### Technical Problem

The disclosure aims to provide apparatus and methods that at least partially address the above needs and/or issues.

### Solution to Problem

In a first aspect, the present disclosure provides a method performed by an access network node, the method comprising: transmitting, in a first cell operated by the access network node, minimum system information associated with a second cell configured to not transmit at least the minimum system information; receiving, from a user equipment, UE, a request for another system information associated with the second cell based on the minimum system information associated with the second cell; and transmitting, to the UE in the first cell, at least a portion of the other system information.

The first cell may be an anchor cell associated with the second cell, and the second cell may be an energy saving cell.

The request may include an indication of the identity of the second cell.

The request may include information identifying the other system information that is requested.

The request may include a bitmap, and each bit of the bitmap may represent a type of the other system information that is requested.

The request may be transmitted in a message 1, msg1 or a message 3, msg3.

The method may further comprise: transmitting, to the UE, an indication that the UE should use other system information associated with the first cell as a remaining portion of the other system information before the transmitting at least a portion of the other system information, to stop the UE to request the remaining portion of the other system information.

The at least the portion of the other system information may be delta information between the first cell and the second cell, and the remaining portion of the other system information may be common information between the first cell and the second cell.

A remaining portion of the other system information may be transmitted to the UE in the second cell.

The method may further comprise: receiving, from another access network node configured to operate the second cell, a first indication indicating updated system information associated with the second cell; transmitting, to the UE, in the first cell, a second indication indicating that the system information associated with the second cell has been updated; and transmitting the updated system information associated with the second cell, in the first cell.

The first indication may include the updated system information associated with the second cell.

The second indication may include a third indication of the type of system information associated with the second cell that has been updated.

The method may further comprise: receiving the third indication from the other access network node.

The third indication may include a fourth indication of whether the updated system information is associated with a public warning service.

The third indication may comprise one or more bits that are used to indicate whether the system information associated with the second cell that has been updated is associated with a public warning service.

The method may further comprise: receiving, from another access network node, an indication indicating that the other system information associated with the second cell operated by the other access network node includes system information corresponding to at least one of a public warning service or an emergency transmission; and determining, based on the other system information, to transmit third system information associated with the first cell, in the first cell, wherein the third system information includes at least one of: the system information corresponding to the at least one of the public warning service or the emergency transmission, or system information corresponding to the at least one of the public warning service or the emergency transmission, associated with the first cell.

The method may further comprise: transmitting an indication of at least one of: an indication of one or more beams for use by the UE to receive the at least the portion of the other system information; or an indication of one or more transmission and reception points, TRPs, for use by the UE to receive the at least the portion of the other system information.

The request may comprise a random access preamble or a system information request in a radio resource control, RRC, message.

In a second aspect, the present disclosure provides a method performed by a user equipment, UE, the method comprising: receiving, in a first cell operated by an access network node, minimum system information associated with a second cell configured to not transmit at least the minimum system information; transmitting, to the access network node, a request for other system information associated with the second cell based on the minimum system information associated with the second cell; and receiving, from the access network node in the first cell, at least a portion of the other system information.

The first cell may be an anchor cell associated with the second cell, and the second cell may be an energy saving cell.

The request may include an indication of the identity of the second cell.

The request may include information identifying the other system information that is requested.

The request may include a bitmap, and each bit of the bitmap may represent a type of the other system information that is requested.

The request may be transmitted in a message 1, msg1 or a message 3, msg3.

The method may further comprise: receiving an indication that the UE should use other system information associated with the first cell as a remaining portion of the other system information before the receiving at least a portion of the other system information; and stopping requesting the remaining portion of the other system information, based on the indication.

The at least the portion of the other system information may be delta information between the first cell and the second cell, and the remaining portion of the other system information may be common information between the first cell and the second cell.

The method may further comprise: receiving a remaining portion of the other system information, in the second cell.

The method may further comprise: receiving, from the access network node in the first cell, a second indication indicating that system information associated with the second cell has been updated; and receiving the updated system information associated with the second cell, in the first cell.

The second indication may include a third indication of the type of system information associated with the second cell that has been updated.

The method may further comprise: receiving, from the access network node in the first cell, third system information associated with the first cell, wherein the third system information includes at least one of: system information corresponding to at least one of the public warning service or the emergency transmission, associated with the second cell, or system information corresponding to the at least one of the public warning service or the emergency transmission, associated with the first cell.

The method may further comprise: receiving an indication of at least one of: an indication of one or more beams for use by the UE to receive the at least the portion of the other system information; or an indication of one or more transmission and reception points, TRPs, for use by the UE to receive the at least the portion of the other system information.

The request may comprise a random access preamble or a system information request in a radio resource control, RRC, message.

In a third aspect, the present disclosure provides an access network node comprising: means for transmitting, in the first cell, minimum system information associated with a second cell configured to not transmit at least the minimum system information; means for receiving, from a user equipment, UE, a request for another system information associated with the second cell; and means for transmitting, to the UE in the first cell, at least a portion of the other system information.

In a fourth aspect, the present disclosure provides a user equipment, UE, comprising: means for receiving, in a first cell operated by an access network node, minimum system information associated with a second cell configured not to transmit at least the minimum system information; means for transmitting, to the access network node, a request for another system information associated with the second cell based on the minimum system information associated with the second cell; and means for receiving, from the access network node in the first cell, at least a portion of the other system information.

### BRIEF DESCRIPTION OF DRAWINGS

Embodiments of the present disclosure will now be described, by way of example, with reference to the accompanying drawings.

FIG. 1 schematically illustrates a mobile (‘cellular’ or ‘wireless’) communication system.

FIG. 2 illustrates a typical frame structure that may be used in the communication system of FIG. 1.

FIG. 3 illustrates an example of an NES cell and an anchor cell.

FIG. 4 illustrates a method in which on-demand SIB is requested in a random access preamble transmission.

FIG. 5 illustrates a method in which on-demand SIB is requested in an RRC system information request.

FIG. 6 illustrates a method in which SI for a non-anchor NES cell is requested from an anchor cell.

FIG. 7 illustrates an example in which a subset of OSI corresponding to the non-anchor NES cell 30 is provided via the anchor NES cell 31.

FIG. 8 illustrates an example of an SI update procedure.

FIG. 9 is a schematic block diagram illustrating the main components of a UE for the communication system of FIG. 1.

FIG. 10 is a schematic block diagram illustrating the main components of a base station for the communication system of FIG. 1.

### DESCRIPTION OF EXAMPLE EMBODIMENTS

### Overview

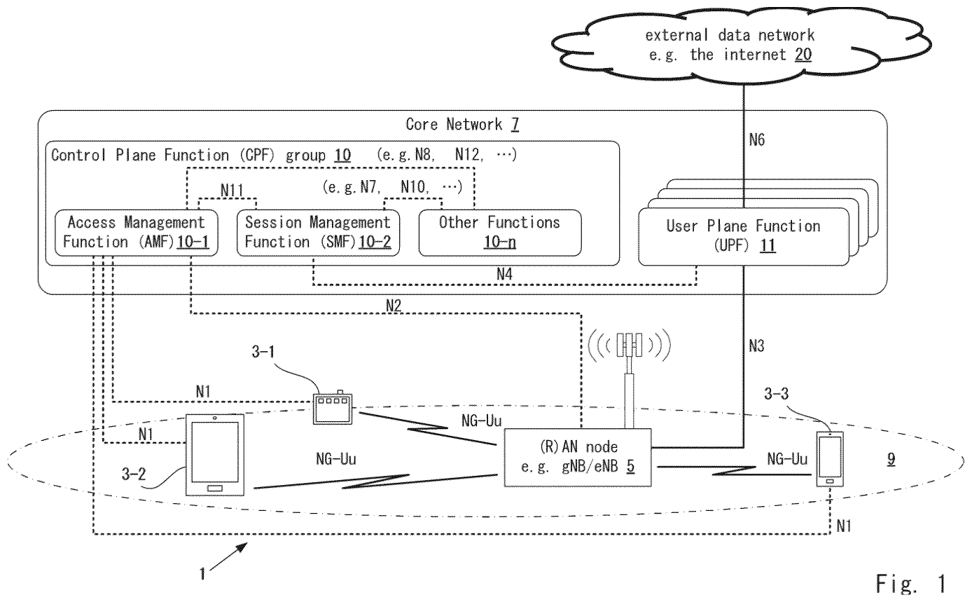

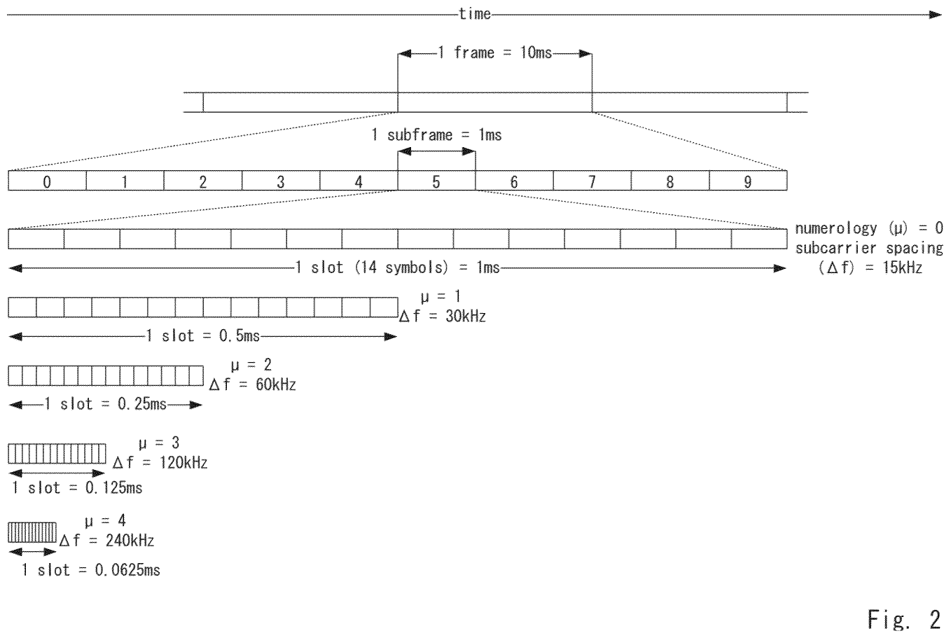

An exemplary communication system will now be described in general terms, by way of example only, with reference to FIGS. 1 and 2.

FIG. 1 schematically illustrates a mobile (‘cellular’ or ‘wireless’) communication system 1 to which embodiments of the present disclosure are applicable.

In the communication system 1 user equipment (UEs) 3-1, 3-2, 3-3 (e.g. mobile telephones and/or other mobile devices) can communicate with each other via a radio access network (RAN) node 5 that operates according to one or more compatible radio access technologies (RATs). In the illustrated example, the RAN node 5 comprises a NR/5G base station or ‘gNB’ 5 operating one or more associated cells 9. Communication via the base station 5 is typically routed through a core network 7 (e.g. a 5G core network or evolved packet core network (EPC)).

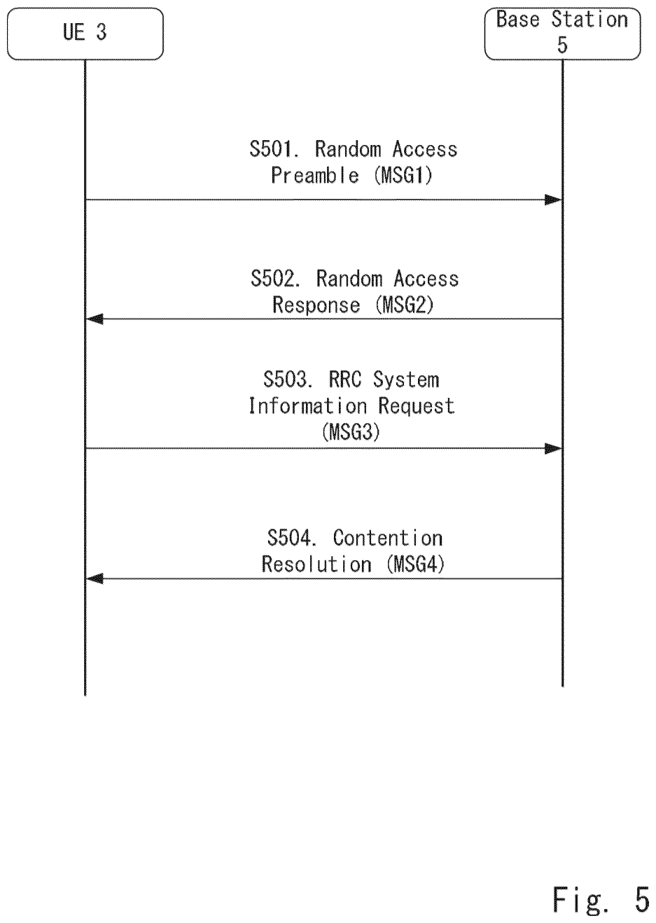

As those skilled in the art will appreciate, whilst three UEs 3 and one base station 5 are shown in FIG. 5 for illustration purposes, the system, when implemented, will typically include other base stations 5 and UEs 3.

Each base station 5 controls the one or more associated cells 9 either directly, or indirectly via one or more other nodes (such as home base stations, relays, remote radio heads, distributed units, and/or the like). It will be appreciated that the base stations 5 may be configured to support 4G, 5G, 6G, and/or any other 3GPP or non-3GPP communication protocols.

The UEs 3 and their serving base station 5 are connected via an appropriate air interface (for example the so-called ‘Uu’ interface and/or the like). Neighbouring base stations 5 may be connected to each other via an appropriate base station to base station interface (such as the so-called ‘X2’ interface, ‘Xn’ interface and/or the like).

The core network 7 includes a number of logical nodes (or ‘functions’) for supporting communication in the communication system 1. In this example, the core network 7 comprises control plane functions (CPFs) 10 and one or more user plane functions (UPFs) 11. The CPFs 10 include one or more Access and Mobility Management Functions (AMFs) 10-1, one or more Session Management Functions (SMFs) and a number of other functions 10-n.

The base station 5 is connected to the core network nodes via appropriate interfaces (or ‘reference points’) such as an N2 reference point between the base station 5 and the AMF 10-1 for the communication of control signalling, and an N3 reference point between the base station 5 and each UPF 11 for the communication of user data. The UEs 3 are each connected to the AMF 10-1 via a logical non-access stratum (NAS) connection over an N1 reference point (analogous to the S1 reference point in LTE). It will be appreciated, that N1 communications are routed transparently via the base station 5.

The one or more UPFs 11 are connected to an external data network (e.g. an IP network such as the internet) via reference point N6 for communication of the user data.

The AMF 10-1 performs mobility management related functions, maintains the NAS signalling connection with each UE 3 and manages UE registration. The AMF 10-1 is also responsible for managing paging. The SMF 10-2 provides session management functionality (that formed part of MME functionality in LTE) and additionally combines some control plane functions (provided by the serving gateway and packet data network gateway in LTE). The SMF 10-2 also allocates IP addresses to each UE 3.

The base station 5 of the communication system 1 is configured to operate at least one cell 9 on an associated TDD carrier that operates in unpaired spectrum. It will be appreciated that the base station 5 may also operate at least one cell 9 on an associated FDD carrier that operates in paired spectrum.

The base station 5 is also configured for transmission of, and the UEs 3 are configured for the reception of, control information and user data via a number of downlink (DL) physical channels and for transmission of a number of physical signals. The DL physical channels correspond to resource elements (REs) carrying information originated from a higher layer, and the DL physical signals are used in the physical layer and correspond to REs which do not carry information originated from a higher layer.

The physical channels may include, for example, a physical downlink shared channel (PDSCH), a physical broadcast channel (PBCH), and a physical downlink control channel (PDCCH). The PDSCH carries data sharing the PDSCH's capacity on a time and frequency basis. The PDSCH can carry a variety of items of data including, for example, user data, UE-specific higher layer control messages mapped down from higher channels, system information blocks (SIBs), and paging. The PDCCH carries downlink control information (DCI) for supporting a number of functions including, for example, scheduling the downlink transmissions on the PDSCH and also the uplink data transmissions on a physical uplink shared channel (PUSCH). The PBCH provides UEs 3 with the Master Information Block, MIB. It also, in conjunction with the PDCCH, supports the synchronisation of time and frequency, which aids cell acquisition, selection and re-selection. The UE 3 may receive a Synchronization Signal Block (SSB), and the UE 3 may assume that reception occasions of a PBCH, primary synchronization signal (PSS) and secondary synchronization signal (SSS) are in consecutive symbols and form a SS/PBCH block. The base station 5 may transmit a number of synchronization signal (SS) blocks corresponding to different DL beams. The total number of SS blocks may be confined, for example, within a 5 ms duration as an SS burst. The periodicity of the SSB transmissions may be indicated to the UE using any suitable signalling (e.g. per serving cell using ssb-periodicityServingCell). The periodicity value for the SSB may be, for example, greater than or equal to 20 ms. For initial cell selection, the UE 3 may be configured to assume that an SS burst occurs with a periodicity of 2 frames. The UE 3 may also be provided with an indication of which SSBs within a 5 ms duration are transmitted (e.g. using ssb-PositionsInBurst).

The DL physical signals may include, for example, reference signals (RSs) and synchronization signals (SSs). A reference signal (sometimes known as a pilot signal) is a signal with a predefined special waveform known to both the UE 3 and the base station 5. The reference signals may include, for example, cell specific reference signals, UE-specific reference signal (UE-RS), downlink demodulation signals (DMRS), and channel state information reference signal (CSI-RS).

Similarly, the UEs 3 are configured for transmission of, and the base station 5 is configured for the reception of, control information and user data via a number of uplink (UL) physical channels corresponding to REs carrying information originated from a higher layer, and UL physical signals which are used in the physical layer and correspond to REs which do not carry information originated from a higher layer. The physical channels may include, for example, the PUSCH, a physical uplink control channel (PUCCH), and/or a physical random-access channel (PRACH). The UL physical signals may include, for example, demodulation reference signals (DMRS) for a UL control/data signal, and/or sounding reference signals (SRS) used for UL channel measurement.

Referring to FIG. 2, which illustrates the typical frame structure that may be used in the communication system 1, the base station 5 and UEs 3 of the communication system 1 communicate with one another using resources that are organised, in the time domain, into frames of length 10 ms. Each frame comprises ten equally sized subframes of 1 ms length. Each subframe is divided into one or more slots comprising 14 Orthogonal frequency-division multiplexing (OFDM) symbols of equal length.

As seen in FIG. 2, the communication system 1 supports multiple different numerologies (subcarrier spacing (SCS), slot lengths and hence OFDM symbol lengths). Specifically, each numerology is identified by a parameter, μ, where μ=0 represents 15 kHz (corresponding to the LTE SCS). Currently, the SCS for other values of u can, in effect, be derived from μ=0 by scaling up in powers of 2 (i.e. SCS=15×2 μkHz). The relationship between the parameter, μ, and SCS (Δf) is as shown in Table 1:

TABLE 1
5G Numerology

| | | Number of slots | |
|---|---|---|---|
| μ | Δf = 2^{μ} · 15[kHz] | per subframe | Slot length (ms) |
| 0 | 15 | 1 | 1 |
| 1 | 30 | 2 | 0.5 |
| 2 | 60 | 4 | 0.25 |
| 3 | 120 | 8 | 0.125 |
| 4 | 240 | 16 | 0.0625 |

### System Information and SIB

It will be appreciated that transmissions in a cell 9 of a base station 5 may include one or more broadcast transmissions and one or more unicast transmissions for reception by a UE 3. System information (SI) transmitted in a cell may include ‘minimum SI’ (MSI) and ‘other SI’ (OSI). The OSI may be broadcast on-demand, for example using a downlink shared channel (DL-SCH).

The OSI may be broadcast upon request from a UE 3 that is in a radio resource control (RRC) idle or RRC inactive state. The OSI may also be requested by a UE 3 that is in the RRC connected state, for example via one or more dedicated RRC transmissions.

The SI may include information for enabling (e.g. configuring) the UE 3 to complete a cell selection procedure (e.g. for a non-anchor NES cell), may include information for enabling the UE 3 to complete a cell reselection procedure, or for enabling the UE 3 to receive one or more paging messages transmitted in a cell (e.g. the non-anchor NES cell). SI may be broadcast using a Master Information Block (MIB) and one or more System Information Blocks (SIB).

The MSI comprises the MIB and system information block 1 (SIB1). The MIB includes information for use by a UE 3 to receive SIB1, for example a subcarrier spacing for SIB1. The MIB provides information corresponding to a Control Resource Set (CORESET) and Search Space. SIB1 may be referred to as ‘remaining MSI’ (RMSI). SIB1 may be transmitted in a dedicated RRC message, and other SIB (e.g. SIB2 to SIB9) may be transmitting using one or more other suitable RRC transmissions. The MIB and SIB1 may provide the UE 3 with an indication of scheduling information for receiving and decoding the other SIB, such as SIB2 to SIB9, and may provide information for use by the UE 3 to receive one or more paging messages. The OSI may comprise, for example, SIB2 to SIB9 transmitted using a DL-SCH in SI messages. A mapping of SIB2 to SIB9 to corresponding SI messages may be provided to the UE 3 by the base station 5. MIB and SIB1 to SIB9 are described in more detail, for example, in 3GPP TS 38.331. For example, SIB2 provides information for intra-frequency, inter-frequency and inter-system cell reselection, SIB3 provides cell-specific information for intra-frequency cell reselection, and SIB4 provides information for inter-frequency cell reselection. SIB5 provides information regarding inter-system cell reselection towards 4G (LTE). SIB6 and SIB7 provide information for an earthquake and tsunami warning system (ETWS). SIB8 provides information for a commercial mobile alert service (CMAS) notification, for example to provide warning text messages to the UE 3. SIB9 includes information regarding coordinated universal time (UTC), global positioning system (GPS) time (e.g. for GPS initialisation) and local time.

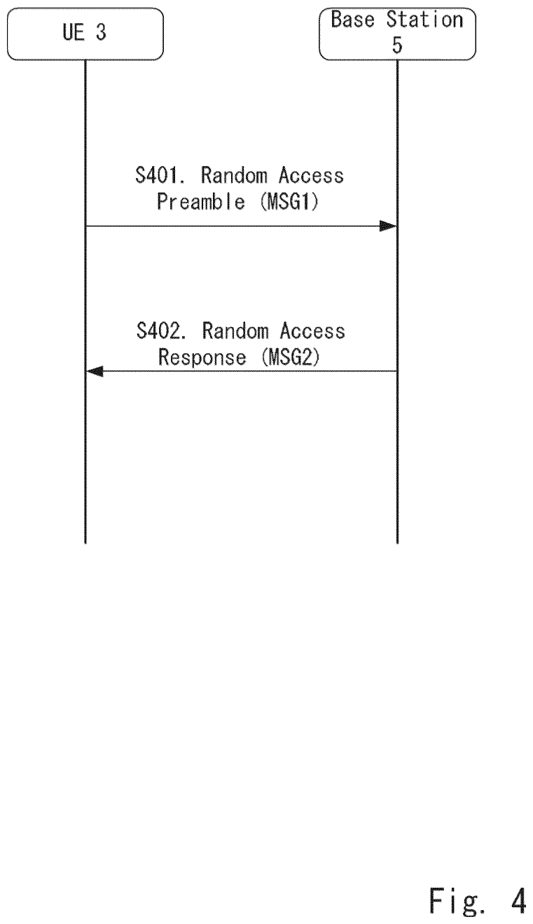

SIB may be broadcast periodically (e.g. according to a predetermined periodic pattern), or alternatively may be provided ‘on-demand’, for example in response to a request from a UE 3. For example, MIB may be transmitted with a periodicity of 80 ms and repetitions made within 80 ms, and SIB1 may be transmitted with a periodicity of 160 ms and a variable transmission repetition periodicity within 160 ms (e.g. 20 ms). SIB1 can be used to indicate to a UE 3 which SIB are transmitted periodically and which SIB are available on-demand in response to a request from the UE 3. A UE 3 may be configured to request on-demand SIB using MSG1 (random access preamble (RA)), which may be referred to as a MSG1-based on-demand SI request, or MSG3 (RRC Connection Request), which may be referred to as a MSG3-based on-demand SI request. FIG. 4 shows an example of a request for SIB using MSG1. In step S401, the UE 3 transmits a random access preamble (MSG1) that includes the request for the on-demand SIB, to the base station 5. The transmission may include information identifying the one or more SIBs that the UE 3 is requesting (for example an explicit or implicit indication of the SIBs). In step S402, the base station 5 transmits a corresponding random access response (MSG2) to the UE 3. MSG2 may include an acknowledgement of the UE's 3 request for the on-demand SIB. FIG. 5 shows an example of a request for SIB using MSG3. In step S501, the UE 3 transmits a random access preamble (MSG1) to the base station 5. In step S502, the base station 5 transmits a random access response (MSG2) to the UE 3. In step S503, the UE 3 transmits an RRC system information request, for example RRCSystemInfoRequest, (MSG3) to the base station 5 that includes the request for the on-demand SIB. MSG3 may include an information identifying the one or more SIBs that the UE 3 is requesting (for example an explicit or implicit indication of the SIBs). In step S504, the base station 5 transmits a contention resolution (MSG4) transmission.

A physical broadcast channel (PBCH) can be used to broadcast the MIB. The base station 5 may transmit the PBCH with synchronisation signals (SS) (e.g. primary synchronisation signal (PSS) and secondary synchronisation signal (SSS)) in a SS/PBCH Block. The SS/PBCH block comprises four orthogonal frequency-division multiplexed (OFDM) symbols that are mapped to PSS, SSS and PBCH associated with a demodulation reference signal (DM-RS). In the frequency domain, an SS/PBCH block consists of 240 contiguous subcarriers. When the UE 3 is in an RRC connected mode, the base station 5 may provide the UE 3 with an indication of resources used for the SS/PBCH, for example using dedicated signalling (e.g. for an anchor NES cell or a non-anchor NES cell). SIB1 may be transmitted using a physical downlink shared channel (PDSCH). The OSI may be similarly transmitted, for example, using a PDSCH.

When one or more beamformed transmissions are transmitted in a cell provided by the base station 5, some of the SI (e.g. some of the SIB) may only be transmitted using particular beams, or using a particular transmission/reception point (TRP).

Methods of providing a UE 3 with configuration information for accessing a non-anchor NES cell are described below. It will be appreciated that these methods may be used to provide the UE 3 with any suitable information for accessing the non-anchor NES cell (e.g. to receive one or more transmissions via the non-anchor NES cell, or to transmit one or more transmissions to a base station that is providing the non-anchor NES cell). For example, the below-described methods may be used to enable the UE 3 to receive any of the above-described SI, SIBs, and/or broadcast transmissions.

### Network Energy Saving (NES) Cells

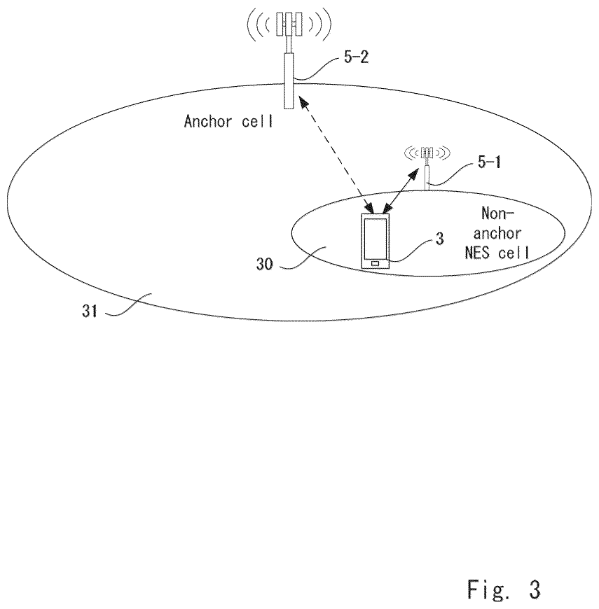

FIG. 3 shows an example of a non-anchor NES cell 30 and a corresponding anchor cell 31. The anchor cell 31 may alternatively be referred to as an “anchor NES cell” 31, and the non-anchor NES cell 30 may simply be referred to as an “NES cell” 30 or “non-anchor cell” 30. In this example the non-anchor NES cell is provided by a first base station 5-1, and the anchor NES cell 31 is provided by a second base station 5-2. However, it will be appreciated that the anchor NES cell 31 and the non-anchor NES cell 30 may alternatively be provided using the same base station 5.

The non-anchor NES cell 30 may be, for example, configured without transmissions of synchronization signal blocks (SSB), or system information blocks (SIB) (or may be a cell in which SSB and/or SIB are not normally transmitted, or are not transmitted according to a default configuration of the non-anchor NES cell 30) in order to reduce the power requirements for operating the cell. More generally, the non-anchor NES cell 30 is configured with a reduced number of broadcast transmissions in order to reduce the amount of energy needed to operate the non-anchor NES cell 30, thereby improving the energy efficiency of the network. However, whilst a non-anchor NES cell 30 may be configured not to transmit a certain type of transmission (e.g. not to broadcast a particular broadcast transmission) at a particular time, the transmission may nevertheless be transmitted in the non-anchor NES cell 30, for example in response to a request from the UE 3 or the base station 5-2 that is operating a corresponding anchor NES cell 31. In other words, some transmissions may be conditionally transmitted in the non-anchor NES cell 30.

Access (e.g. initial access) by the UE 3 of the non-anchor NES cell 30 may be configured via the anchor NES cell 31. Alternatively, access by the UE 3 of the non-anchor NES cell 30 may be configured directly via the non-anchor NES cell 30. If direct access to the non-anchor NES cell 30 is supported, then a SIB transmitted using the anchor NES cell 31 includes the information used by the UE 3 to access the non-anchor NES cell 30. The UE 3 is operable to receive a configuration for accessing the non-anchor NES cell 30 from the anchor NES cell 31. For example, when the UE 3 is in an RRC connected state, the UE 3 may receive UE-specific RRC signalling for configuring the UE 3 to receive one or more unicast transmissions in the non-anchor NES cell 30. Particularly advantageous examples of how SI can be provided to the UE 3 in order for the UE 3 to access and use the non-anchor NES cell 30 will now be described.

### On-Demand SI for NES Cell Provided by Anchor Cell

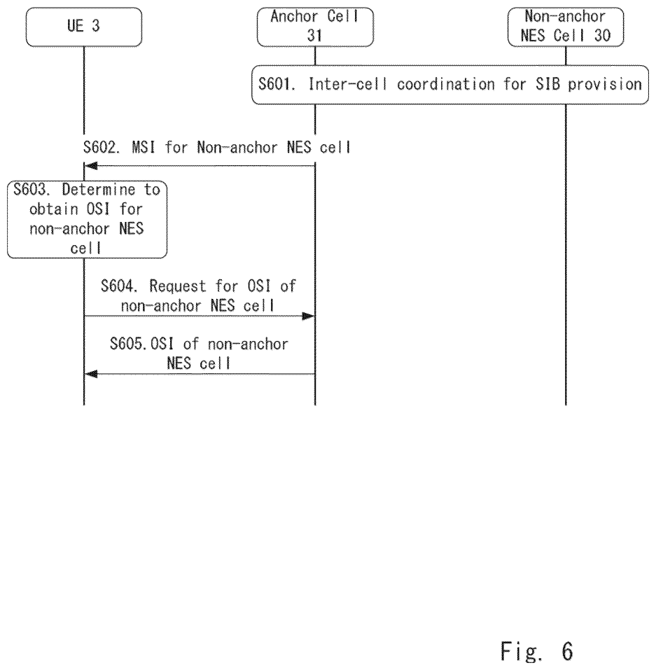

An example in which the UE 3 acquires the MSI from the anchor NES cell 31 will now be described with reference to FIG. 6. In this example, the OSI corresponding to the non-anchor NES cell 30 is requested by the UE 3 in an on-demand manner from the anchor NES cell 31. Advantageously, therefore, the OSI of the non-anchor NES cell 30 need not necessarily always be broadcast in the anchor NES cell 31 or the non-anchor NES cell 30, improving the efficiency of the system.

In step S601, inter-cell coordination for SIB provisioning is performed between the anchor NES cell 31 and the non-anchor NES cell 30. For example, the anchor NES cell 31 may be configured for broadcast of the MIB and SIB1 for the non-anchor NES cell 30. It will be appreciated that if the SIB provisioning is preconfigured for the anchor NES cell 31 and the non-anchor NES cell 30, then step S601 need not necessarily be performed.

In step S602, the UE 3 receives the MSI (MIB and SIB1) for the non-anchor NES cell 30 via the anchor NES cell 31. It will be appreciated that whilst in FIG. 6 transmission of the MSI to the UE 3 is represented as a single step, the MIB and SIB1 may be transmitted to the UE 3 in separate transmissions (for example, in broadcast manner).

In step S603, the UE 3 determines to obtain OSI corresponding to the non-anchor NES cell 30. For example, the UE 3 may determine to obtain one or more of SIB2 to SIB9.

In step S604, the UE 3 transmits a request for the OSI corresponding to the non-anchor NES cell 30. The request may be in the form of, for example, any suitable RRC message. In this example, the request for SI transmitted by the UE 3 includes an indication of the identity of the non-anchor NES cell 30 for which the SI is requested, for example any suitable cell ID. The request also includes an indication of the SI that is requested (e.g. information identifying one or more SIBs). The indication of the SI that is requested may include, for example, a SIB number. The SIB number may be identified using a corresponding bitmap provided for each non-anchor NES cell 30. The request transmitted by the UE 3 may be included, for example, in MSG1 (as described above with reference to FIG. 4) or in MSG3 (as described above with reference to FIG. 5), or in any other suitable transmissions. The request transmitted by the UE 3 may be included in a dedicated RRC message, for example as specified in 3GPP TS38.331 (for example, in RRCSystemInfoRequest message) when the UE 3 is in an RRC CONNECTED state with the anchor NES cell 31.

When MSG3 (or a dedicated RRC message) transmitted by the UE 3 includes the request for the SI, the indication of the identity of the NES cell for which the SI is requested may be provided in any suitable information element (IE) in MSG3. Similarly, the indication of the requested SIB may be provided in any suitable IE in MSG3 (e.g. the same IE used to provide the identity of the NES cell).

If the UE 3 is synchronised for communication using the anchor NES cell 31 then a layer 1 (L1)/layer 2 (L2) procedure may be used to request the SI rather than MSG1 (random access preamble), since in this case random access is not needed for synchronisation.

Advantageously, the provision of the indication of the identity of the non-anchor NES cell 30 for which SI is requested enables the base station 5-2 providing the anchor NES cell 31 to distinguish between requests for OSI corresponding to the anchor NES cell 31 and requests for OSI corresponding to a non-anchor NES cell 30. In this example, the base station 5-2 that provides the anchor NES cell 31 determines that the request is for OSI corresponding to the non-anchor NES cell 30, and in step S605, the base station 5-2 transmits the requested OSI corresponding to the non-anchor NES cell 30 to the UE 3.

In a modified version of step S605, the base station 5-2 may provide an indication to the UE 3 of one or more resources to be used to receive the requested OSI. For example, the base station 5-2 may provide an indication to the UE 3 of one or more beams or TRPs via which the requested OSI is to be transmitted to the UE 3.

In step S605, the base station 5-2 may transmit a requested SI to the UE 3, or may alternatively transmit only the differences between the corresponding SI of the anchor NES cell 31 and the requested SI of the non-anchor NES cell 30. In other words, the base station 5-2 may transmit a delta-configuration of the requested SI (e.g. requested SIB) to the UE 3, advantageously reducing the size of the information that is transmitted to the UE 3.

The base station 5-2 may determine that the UE 3 is to use one or more SIB corresponding to the anchor NES cell 31 for the non-anchor NES cell 30, in which case the base station 5-2 may transmit an indication of the SIB of the anchor NES cell 31 that the UE 3 is to use for the non-anchor NES cell 30. The indication of the SIB of the anchor NES cell 31 that the UE 3 is to use for the non-anchor NES cell 30 may be provided to the UE 3 from the base station 5-2 that provides the anchor NES cell 31 via L1/L2/L3 signalling. If this indication is provided to the UE 3 before the UE 3 requests the OSI corresponding the non-anchor NES cell 30 from the base station 5-2 in step S604, then advantageously step S604 need not be performed if the SIB of the anchor NES cell 31 corresponding to the OSI of the non-anchor NES cell 30 that would be requested by the UE 3 is already available at the UE 3 via the anchor NES cell 31.

On-demand SI for NES cell partially provided by anchor cell

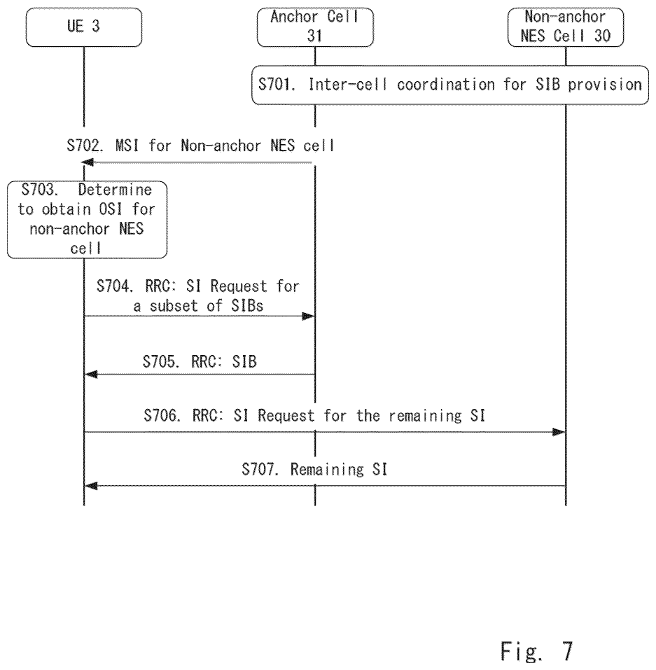

An example in which a subset of the OSI corresponding to the non-anchor NES cell 30 is provided via the anchor NES cell 31 will now be described with reference to FIG. 7.

Steps S701 and S702 correspond to steps S601 and S602 of FIG. 6 and will not be described again in detail here. The UE 3 obtains the MSI for the non-anchor NES cell 30 based on broadcast signalling in the anchor NES cell 31 for the provision of SI for the non-anchor NES cell 30.

In step S703, the UE 3 determines to obtain OSI corresponding to the non-anchor NES cell 30. For example, the UE 3 may determine to obtain one or more of SIB2 to SIB9.

In step S704, the UE 3 requests a subset of the OSI that the UE 3 determined to obtain, from the anchor NES cell 31. The request corresponds to the request of S604 of FIG. 6, except that the request is for a subset of the OSI that the UE 3 determined to obtain for the non-anchor NES cell 30, rather than for all of the OSI that the UE 3 determined to obtain for the non-anchor NES cell 30.

In step S705, analogous to step S605 of FIG. 6, the UE 3 receives the requested OSI via the anchor NES cell 31. The base station 5-2 may transmit an indication to the UE 3 of the remaining OSI that is to be received from the non-anchor NES cell 30, or alternatively the UE 3 may determine the remaining OSI that is to be received from the non-anchor NES cell 30 based on the system information received via the anchor NES cell 31 in step S705.

In step S706, the UE 3 requests the remaining OSI (that has not been received in step S705) from the non-anchor NES cell 30. The request may include an explicit indication or an implicit indication of the SI that is requested (e.g. a SIB number).

In step S707, the UE 3 receives the requested OSI from the non-anchor NES cell 30 in any suitable signalling (e.g. RRC signalling). In a case in which the non-anchor NES cell 30 is not configured for the transmission of SIB, the OSI may be provided to the UE 3 via the non-anchor NES cell 30 using any suitable broadcast or dedicated signalling for the UE 3. Advantageously, therefore, the UE 3 is still able to obtain the OSI corresponding to the non-anchor NES cell 30 even when the non-anchor NES cell 30 is a SIB-less cell.

### SI Update by Anchor Cell

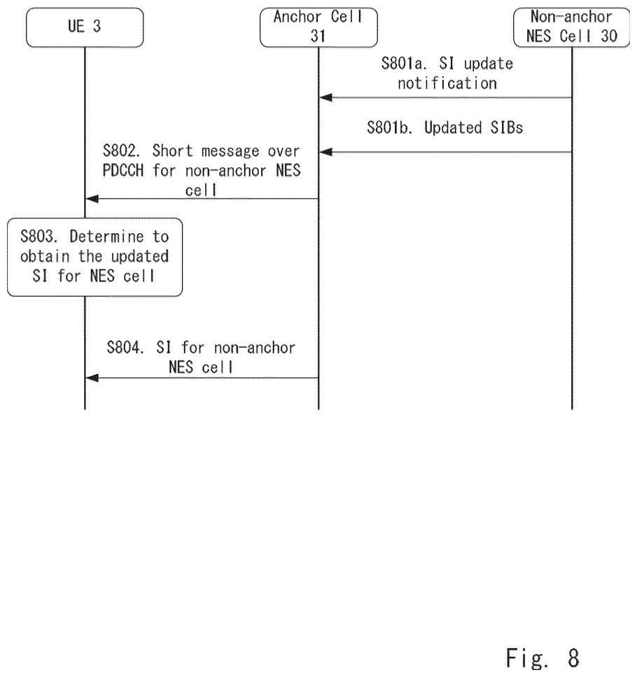

An example in which SI for the non-anchor NES cell 30 is updated via the anchor NES cell 31 will now be described with reference to FIG. 8. The method comprises an update of the SI corresponding to the non-anchor NES cell 30 that is forwarded to the UE 3 via the anchor NES cell 31. In this example, a short message is used to provide an SI update for a particular cell. Table 2 below shows an example of how the bits of an 8 bit short message for an SI may be used:

TABLE 2

| Bit | Short Message |
|---|---|
| 1 | System Information Modification (e.g. systemInfoModification) |
| | If set to 1: Indication of a BCCH modification other than SIB6, SIB7 |
| | and SIB 8 |
| 2 | ETWS and CMAS Indication (e.g. etwsAndCmasIndication) |
| | If set to 1: indication of an ETWS primary notification and/or an |
| | ETWS secondary notification and/or a CMAS notification. |
| 3-8 | Not used, and ignored by the UE if received |

As shown in Table 2, bit 1 corresponds to a system information modification indication. This bit is used to indicate whether a broadcast control channel (BCCH) modification is for other than SIB6, SIB7 and SIB 8. Bit 2 corresponds to an ETWS and CMAS indication that indicates whether the message corresponds to an indication of an ETWS primary notification and/or an ETWS secondary notification and/or a CMAS notification.

Referring now to FIG. 8, in step S801a, an SI update notification is transmitted from the non-anchor NES cell 30 to the anchor NES cell 31 (from the base station 5-1 that operates the non-anchor NES cell 30 to the base station that operates the anchor NES cell 31). The SI update notification provides an indication that an update of SI corresponding to the non-anchor NES cell 30 has occurred. The SI update notification may include a short message that indicates the type SI update (e.g. of the type illustrated in Table 2 above). Alternatively, no short message may be transmitted from the non-anchor NES cell 30 to the anchor NES cell 31. It will be appreciated that the Xn interface can be used for the transmissions from the base station 5-1 that provides the non-anchor NES cell 30 to the base station 5-2 that provides the anchor NES cell 31.

In step S801b, the updated SIBs are transmitted from the non-anchor NES cell to the anchor NES cell 31.

In step S802, a short message is transmitted to the UE 3 using the anchor NES cell 31 that provides an indication that an update of SI has occurred for the non-anchor NES cell 30. The short message may be, for example, of the form illustrated in Table 2. In this example the short message is transmitted using PDCCH; however, it will be appreciated that this need not necessarily be the case, and any other suitable type of transmission could be used (e.g. any suitable RRC message, broadcast transmission, or UE 3 specific signalling). L1/L2/L3 signalling may be used to notify the UE 3 of the SI update at the non-anchor NES cell 30. The transmission transmitted to the UE 3 in step S802 may provide an explicit or implicit indication that the SI update corresponds to the non-anchor NES cell 30 rather than to the anchor NES cell 31 (for example, a suitable information element or fields).

In step S803, the UE 3 determines to obtain the updated SI for the non-anchor NES cell 30.

In step S804, the UE 3 receives the updated SI for the non-anchor NES cell 30 via the anchor NES cell 31. In this example one or more SIB corresponding to the updated SI are received via the anchor NES cell 31 in an RRC transmission; however, it will be appreciated that any other suitable type of transmission for providing the updated SI to the UE 3 via the anchor NES cell 31 may alternatively be used.

### PWS and Emergency Information

Public warning service (PWS) transmissions include the above-described ETWS and CMAS transmissions (SIB6, SIB7, SIB8). These SIB are delay sensitive, since they may relate to emergency situations (for example, an earthquake and/or tsunami). Moreover, there may be a need to alert every served UE 3, including UEs 3 in RRC idle or RRC inactive mode (e.g. camping UEs 3) of the emergency information. Therefore, the PWS notification may be maintained in a short message (e.g. in similar manner as described above with reference to Table 2).

In a first option, the anchor NES cell 31 may transmit the ETWS and CMAS messages corresponding to the non-anchor NES cell 30 in a container/transmission corresponding to ETWS and CMAS transmissions of the anchor NES cell 31.

In a second option, if the non-anchor NES cell 30 is full covered by the anchor NES cell 31 (the non-anchor NES cell 30 is entirely inside the anchor NES cell 31 as illustrated in FIG. 3), the ETWS and CMAS message of the non-anchor NES cell 30 may be ignored by the base station 5-2 that provides the anchor NES cell 31, and the ETWS and CMAS messages of the anchor NES cell 31 may be used to provide the ETWS and/or CMAS information to the one or more UEs 3.

Advantageously, therefore, UEs 3 can be efficiently and reliably notified of the ETWS and/or CMAS information (which may relate to an emergency situation) even when the corresponding SI is not transmitted directly to the one or more UEs 3 using the non-anchor NES cell 30.

### User Equipment

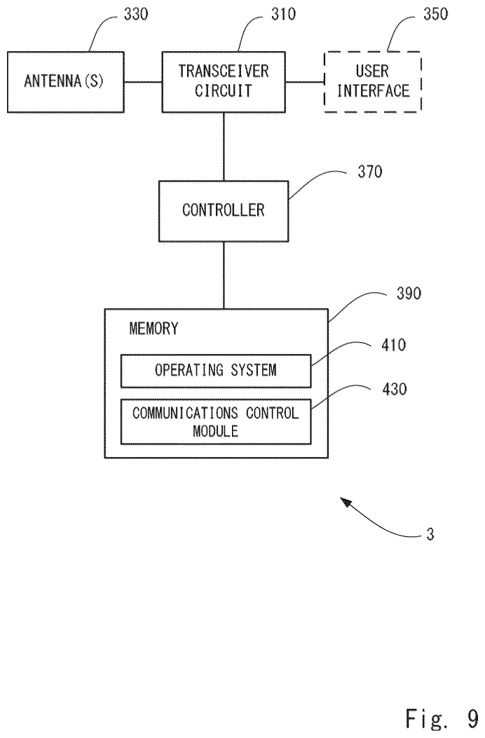

FIG. 9 is a schematic block diagram illustrating the main components of a UE 3 as shown in FIG. 1.

As shown, the UE 3 has a transceiver circuit 310 that is operable to transmit signals to and to receive signals from a base station 5 via one or more antenna 330 (e.g., comprising one or more antenna elements). The UE 3 has a controller 370 to control the operation of the UE 3. The controller 370 is associated with a memory 390 and is coupled to the transceiver circuit 310. Although not necessarily required for its operation, the UE 3 might, of course, have all the usual functionality of a conventional UE 3 (e.g. a user interface 350, such as a touch screen/keypad/microphone/speaker and/or the like for, allowing direct control by and interaction with a user) and this may be provided by any one or any combination of hardware, software, and firmware, as appropriate. Software may be pre-installed in the memory 390 and/or may be downloaded via the communication system 1 or from a removable data storage device (RMD), for example.

The controller 370 is configured to control overall operation of the UE 3 by, in this example, program instructions or software instructions stored within memory 390. As shown, these software instructions include, among other things, an operating system 410, and a communications control module 430.

The communications control module 430 is operable to control the communication between the UE 3 and its serving one or more base stations 5 (and other communication devices connected to the base station 5, such as further UEs and/or core network nodes). The communications control module 430 is configured for the overall handling uplink communications via associated uplink channels (e.g. via a physical uplink control channel (PUCCH), random access channel (RACH), and/or a physical uplink shared channel (PUSCH)) including both dynamic and semi-static signalling (e.g., SRS). The communications control module 430 is also configured for the overall handling of receipt of downlink communications via associated downlink channels (e.g. via a physical downlink control channel (PDCCH) and/or a physical downlink shared channel (PDSCH)) including both dynamic and semi-static signalling (e.g., CSI-RS). The communications control module 430 is responsible, for example: for determining where to monitor for downlink control information (e.g., the location of CSSs/USSs, CORESETs, and associated PDCCH candidates to monitor); for determining the resources to be used by the UE 3 for transmission/reception of UL/DL communications (including interleaved resources and resources subject to frequency hopping); for managing frequency hopping at the UE side; for determining how slots/symbols are configured (e.g., for UL, DL or SBFD communication, or the like); for determining which one or more bandwidth parts are configured for the UE 3; for determining how uplink transmissions should be encoded; for applying any SBFD specific communication configurations appropriately; and the like. The communications control module 430 may be configured to control communications in accordance with any of the methods described above (for example, to perform communication with an anchor NES cell 31 and/or a non-anchor NES cell 30).

### Base Station

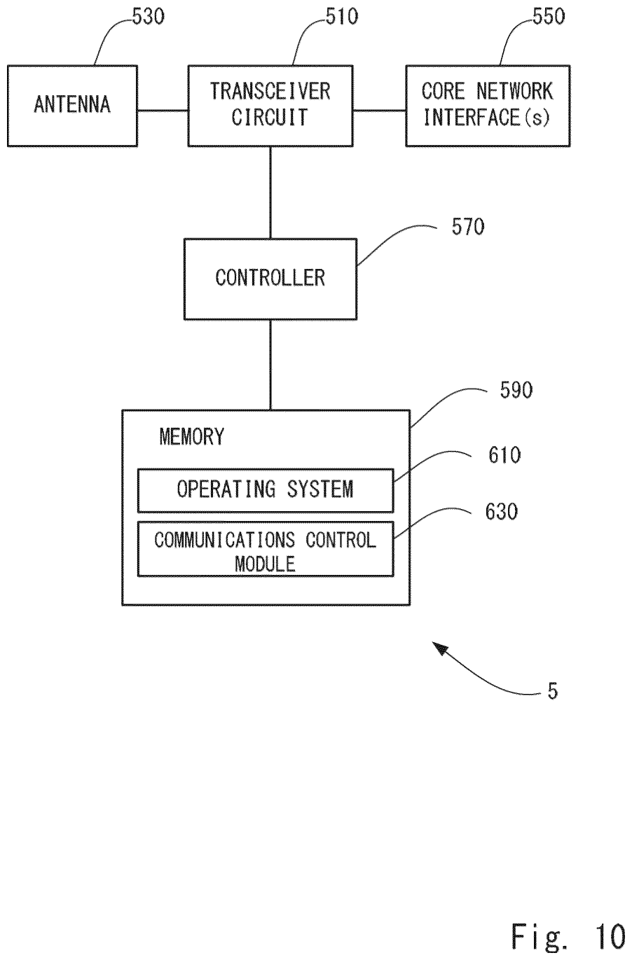

FIG. 10 is a schematic block diagram illustrating the main components of the base station 5 for the communication system 1 shown in FIG. 1. As shown, the base station 5 has a transceiver circuit 510 for transmitting signals to and for receiving signals from the communication devices (such as UEs 3) via one or more antenna 530 (e.g. a single or multi-panel antenna array/massive antenna), and a core network interface 550 (e.g. comprising the N2, N3 and other reference points/interfaces) for transmitting signals to and for receiving signals from network nodes in the core network 7. Although not shown, the base station 5 may also be coupled to other base stations via an appropriate interface (e.g. the so-called ‘Xn’ interface in NR). The base station 5 has a controller 570 to control the operation of the base station 5. The controller 570 is associated with a memory 590. Software may be pre-installed in the memory 590 and/or may be downloaded via the communication system 1 or from a removable data storage device (RMD), for example. The controller 570 is configured to control the overall operation of the base station 5 by, in this example, program instructions or software instructions stored within the memory 590.

As shown, these software instructions include, among other things, an operating system 610 and a communications control module 630.

The communications control module 630 is operable to control the communication between the base station 5 and UEs 3 and other network entities that are connected to the base station 5. The communications control module 630 is configured for the overall control of the reception and decoding of uplink communications, via associated uplink channels (e.g. via a physical uplink control channel (PUCCH), a random-access channel (RACH), and/or a physical uplink shared channel (PUSCH)) including both dynamic and semi-static signalling (e.g., SRS). The communications control module 630 is also configured for the overall handling the transmission of downlink communications via associated downlink channels (e.g. via a physical downlink control channel (PDCCH) and/or a physical downlink shared channel (PDSCH)) including both dynamic and semi-static signalling (e.g., CSI-RS). The communications control module 630 is responsible for managing full duplex (e.g., SBFD) communication including, where appropriate, the segregation of UL and DL communication via different physical antenna elements. The communications control module 630 is responsible, for example: for determining where to configure the UE 3 to monitor for downlink control information (e.g., the location of CSSs/USSs, CORESETs, and associated PDCCH candidates to monitor); for determining the resources to be scheduled for UE transmission/reception of UL/DL communications (including interleaved resources and resources subject to frequency hopping); for managing frequency hopping at the base station side; for configuring slots/symbols appropriately (e.g., for UL, DL or SBFD communication, or the like); for configuring one or more bandwidth parts for the UE 3; for providing related configuration signalling to the UE 3; and the like. The communications control module 43 may be configured to control communications in accordance with any of the methods described above (for example, to provide the UE 3 with information for use in configuring the UE 3 to communicate using an anchor NES cell 31 and/or a non-anchor NES cell 30 provided by a base station 5).

### Modifications and Alternatives

As those skilled in the art will appreciate, a number of modifications and alternatives can be made to the above embodiments whilst still benefiting from the present disclosure.

The non-anchor NES cell 30 and the anchor NES cell 31 in any of the above-described examples may be, for example, for providing a narrowband internet-of-things (NB-IoT) service. However, it will be appreciated that this need not necessarily be the case. When the non-anchor NES cell 30 and the anchor NES cell 31 are for providing a NB-IoT service, the UE 3 may be configured to operate based on a narrowband primary synchronization signal (NPSS), narrowband secondary synchronization signal (NSSS), NB-IoT physical broadcast channel (NPBCH), and/or narrowband system information block (SIB-NB) not being transmitted in the non-anchor NES cell 30 (or based on the non-anchor NES cell not transmitting NPSS, NSSS, NPBCH and/or SIB-NB by default, or at a particular time; the non-anchor NES cell 30 may be configurable for transmission of NPSS, NSSS, NPBCH and/or SIB-NB in the NES in response to a request from the UE 3, for example). The UE 3 may also be configured to operate based on the anchor NES cell 31 being configured for transmitting the NPSS, NSSS, NPBCH and/or SIB-NB.

It will be appreciated, for example, that whilst cellular communication generation (2G, 3G, 4G, 5G, 6G etc.) specific terminology may be used, in the interests of clarity, to refer to specific communication entities, the technical features described for a given entity are not limited to devices of that specific communication generation. The technical features may be implemented in any functionally equivalent communication entity regardless of any differences in the terminology used to refer to them.

In the above description, the UEs and the base station are described for ease of understanding as having a number of discrete functional components or modules. Whilst these modules may be provided in this way for certain applications, for example where an existing system has been modified to implement the present disclosure, in other applications, for example in systems designed with the inventive features in mind from the outset, these modules may be built into the overall operating system or code and so these modules may not be discernible as discrete entities.

In the above embodiments, a number of software modules were described. As those skilled in the art will appreciate, the software modules may be provided in compiled or un-compiled form and may be supplied as a signal over a computer network, or on a recording medium. Further, the functionality performed by part, or all of this software may be performed using one or more dedicated hardware circuits. However, the use of software modules is preferred as it facilitates the updating of the base station or the UE in order to update their functionalities.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like. Various other modifications will be apparent to those skilled in the art and will not be described in further detail here.

The base station may comprise a ‘distributed’ base station having a central unit ‘CU’ and one or more separate distributed units (DUs).

The User Equipment (or “UE”, “mobile station”, “mobile device” or “wireless device”) in the present disclosure is an entity connected to a network via a wireless interface.

It should be noted that the present disclosure is not limited to a dedicated communication device and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyser, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table. This list is not exhaustive and is intended to be indicative of some examples of machine type communication applications.

| Service Area | MTC applications |
|---|---|
| Security | Surveillance systems |
| | Backup for landline |
| | Control of physical access (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote Maintenance/ | Sensors |
| Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an MVNO (Mobile Virtual Network Operator) service, an emergency radio communication system, a PBX (Private Branch exchange) system, a PHS/Digital Cordless Telecommunications system, a POS (Point of sale) system, an advertise calling system, an MBMS (Multimedia Broadcast and Multicast Service), a V2X (Vehicle to Everything) system, a train radio system, a location related service, a Disaster/Emergency Wireless Communication Service, a community service, a video streaming service, a femto cell application service, a VoLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and exemplary embodiments described in the present document. Needless to say, these technical ideas and embodiments are not limited to the above-described UE and various modifications can be made thereto.

Various other modifications will be apparent to those skilled in the art and will not be described in further detail here.

This application is based upon and claims the benefit of priority from United Kingdom Patent Application No. 2218671.2, filed on Dec. 12, 2022, the disclosure of which is incorporated herein in its entirety by reference.

For example, the whole or part of the exemplary example embodiments disclosed above can be described as, but not limited to, the following supplementary notes.

### Supplementary Note 1

A method performed by an access network node that is configured to provide a first cell for communicating with a user equipment, UE, the method comprising:
transmitting, in the first cell, first system information that is associated with a second cell that is not transmitting the first system information;
receiving, from the UE, a request for second system information that is associated with the second cell; and
transmitting at least a portion of the second system information in the first cell, for reception of the second system information by the UE.

### Supplementary Note 2

The method according to Supplementary note 1, wherein the first system information comprises at least one of information for initial access by the UE to the second cell, and information for use by the UE to acquire additional system information.

### Supplementary Note 3

The method according to Supplementary note 2, wherein the first system information is included in a master information block, MIB, that is associated with the second cell.

### Supplementary Note 4

The method according to any preceding Supplementary note, wherein the first cell is an anchor cell associated with the second cell, and the second cell is an energy saving cell.

### Supplementary Note 5

The method according to any preceding Supplementary note, wherein the request received from the UE includes an indication of the identity of the second cell.

### Supplementary Note 6

The method according to any preceding Supplementary note, wherein the request received from the UE includes information identifying the second system information that is requested.

### Supplementary Note 7

The method according to Supplementary note 6, wherein the second system information is identified in the request using a bitmap that is associated with the second cell.

### Supplementary Note 8

The method according to any preceding Supplementary note, wherein the method comprises:
transmitting a first portion of the second system information in the first cell, for reception of the second system information by the UE; and
transmitting an indication to the UE that the UE is to receive a second portion of the second system information via a transmission in the second cell.

### Supplementary Note 9

The method according to Supplementary note 8, wherein the indication that the UE is to receive the second portion of the second system information via a transmission in the second cell includes an indication of at least one of:
an indication of one or more beams for use by the UE to receive the second portion of the second system information; or
an indication of one or more transmission and reception points, TRPs, for use by the UE to receive the second portion of the second system information.

### Supplementary Note 10

The method according to any preceding Supplementary note, wherein the request for second system information comprises a random access preamble or a system information request in a radio resource control, RRC, message.

### Supplementary Note 11

The method according to any preceding Supplementary note, further comprising transmitting an indication, to the UE, that the UE is to use third system information that is associated with the first cell to communicate using the second cell.

### Supplementary Note 12

A method performed by a user equipment, UE, the method comprising:
receiving, in a first cell provided by an access network node, first system information that is associated with a second cell that is not transmitting the first system information;
transmitting, to the access network node, a request for second system information that is associated with the second cell; and
receiving at least a portion of the second system information in the first cell from the access network node.

### Supplementary Note 13

The method according to Supplementary note 12, wherein the first system information comprises at least one of information for initial access by the UE to the second cell, and information for use by the UE to acquire additional system information.

### Supplementary Note 14

The method according to Supplementary note 13, wherein the first system information is included in a master information block, MIB, that is associated with the second cell.

### Supplementary Note 15

The method according to any one of Supplementary notes 12 to 14, wherein the first cell is an anchor cell associated with the second cell, and the second cell is an energy saving cell.

### Supplementary Note 16

The method according to any one of Supplementary notes 12 to 15, wherein the request transmitted by the UE includes an indication of the identity of the second cell.

### Supplementary Note 17

The method according to any one of Supplementary notes 12 to 16, wherein the request transmitted by the UE includes information identifying the second system information that is requested.

### Supplementary Note 18

The method according to Supplementary note 17, wherein the second system information is identified in the request using a bitmap that is associated with the second cell.

### Supplementary Note 19

The method according to any one of Supplementary notes 12 to 18, wherein the method comprises:
receiving a first portion of the second system information in the first cell; and
receiving an indication that the UE is to receive a second portion of the second system information via a transmission in the second cell.

### Supplementary Note 20

The method according to Supplementary note 19, wherein the indication that the UE is to receive the second portion of the second system information via a transmission in the second cell includes an indication of at least one of:
an indication of one or more beams for use by the UE to receive the second portion of the second system information; or
an indication of one or more transmission and reception points, TRPs, for use by the UE to receive the second portion of the second system information.

### Supplementary Note 21

The method according to any one of Supplementary notes 12 to 20, wherein the request for second system information comprises a random access preamble or a system information request in a radio resource control, RRC, message.

### Supplementary Note 22

The method according to any one of Supplementary notes 12 to 21, further comprising receiving an indication, from the access network node, that the UE is to use third system information that is associated with the first cell to communicate using the second cell.

### Supplementary Note 23

A method performed by a first access network node that is configured to provide a first cell for communicating with a user equipment, UE, the method comprising:
receiving, from a second access network node that is configured to provide a second cell for communicating with the UE, a first indication that indicates updated system information that is associated with the second cell;
transmitting, to the UE, using the first cell, a second indication that indicates that the system information associated with the second cell has been updated; and
transmitting the updated system information that is associated with the second cell in the first cell, for reception of the updated system information by the UE.

### Supplementary Note 24

The method according to Supplementary note 23, wherein the method further comprises receiving, from the second access network node, an indication of the type of system information associated with the second cell that has been updated.

### Supplementary Note 25

The method according to Supplementary note 24, wherein the indication of the type of system information associated with the second cell that has been updated includes an indication of whether the updated system information is associated with a public warning service.

### Supplementary Note 26

The method according to any one of Supplementary notes 23 to 25, wherein the second indication transmitted to the UE includes an indication of the type of system information associated with the second cell that has been updated.

### Supplementary Note 27

The method according to Supplementary note 26, wherein the indication of the type of system information associated with the second cell that has been updated comprises one or more bits that are used to indicate whether the system information associated with the second cell that has been updated is associated with a public warning service.

### Supplementary Note 28

A method performed by a user equipment, UE, the method comprising:
receiving, using a first cell, from a first access network node that provides the first cell, an indication that indicates that system information associated with a second cell provided by a second access network node has been updated;
determining to obtain the updated system information that is associated with the second cell using the first cell; and
receiving, from the first access network node, the updated system information that is associated with the second cell in the first cell.

### Supplementary Note 29

The method according to Supplementary note 28, wherein the indication that indicates that system information associated with a second cell provided by a second access network node has been updated includes an indication of the type of system information associated with the second cell that has been updated.

### Supplementary Note 30

The method according to Supplementary note 29, wherein the indication of the type of system information associated with the second cell that has been updated comprises one or more bits that are used to indicate whether the system information associated with the second cell that has been updated is associated with a public warning service.

### Supplementary Note 31

A method performed by a second access network node that is configured to provide a second cell for communicating with a user equipment, UE, the method comprising:
transmitting, to a first access network node that is configured to provide a first cell for communicating with the UE, a first indication that indicates updated system information that is associated with the second cell; and
communicating with the UE in the second cell using the updated system information in the second cell.

### Supplementary Note 32

The method according to Supplementary note 31, wherein the method further comprises transmitting, to the first access network node, an indication of the type of system information associated with the second cell that has been updated.

### Supplementary Note 33

The method according to Supplementary note 32, wherein the indication of the type of system information associated with the second cell that has been updated includes an indication of whether the updated system information is associated with a public warning service.

### Supplementary Note 34

A method performed by a first access network node that is configured to provide a first cell for communicating with a user equipment, UE, the method comprising:
transmitting, in the first cell, first system information that is associated with a second cell that is not transmitting the first system information, wherein the second cell is provided by a second access network node;
receiving, from the second access network node, an indication of second system information that is associated with the second cell and that includes information corresponding to at least one of a public warning service or an emergency transmission; and
determining, based on the second system information, to transmit third system information associated with the first cell, using the first cell, wherein the third system information includes the information corresponding to the at least one of the public warning service or the emergency transmission.

### Supplementary Note 35

An access network node that is configured to provide a first cell for communicating with a user equipment, UE, the access network node comprising:
means for transmitting, in the first cell, first system information that is associated with a second cell that is not transmitting the first system information;
means for receiving, from the UE, a request for second system information that is associated with the second cell; and
means for transmitting at least a portion of the second system information in the first cell, for reception of the second system information by the UE.

### Supplementary Note 36

A user equipment, UE, comprising:
means for receiving, in a first cell provided by an access network node, first system information that is associated with a second cell that is not transmitting the first system information;
means for transmitting, to the access network node, a request for second system information that is associated with the second cell; and
means for receiving at least a portion of the second system information in the first cell from the access network node.

### Supplementary Note 37

A first access network node that is configured to provide a first cell for communicating with a user equipment, UE, the first access network node comprising:
means for receiving, from a second access network node that is configured to provide a second cell for communicating with the UE, a first indication that indicates updated system information that is associated with the second cell;
means for transmitting, to the UE, using the first cell, a second indication that indicates that the system information associated with the second cell has been updated; and
means for transmitting the updated system information that is associated with the second cell in the first cell, for reception of the updated system information by the UE.

### Supplementary Note 38

A user equipment, UE, comprising:
means for receiving, using a first cell, from a first access network node that provides the first cell, an indication that indicates that system information associated with a second cell provided by a second access network node has been updated;
means for determining to obtain the updated system information that is associated with the second cell using the first cell; and
means for receiving, from the first access network node, the updated system information that is associated with the second cell in the first cell.

### Supplementary Note 39

A second access network node that is configured to provide a second cell for communicating with a user equipment, UE, the second access network node comprising:
means for transmitting, to a first access network node that is configured to provide a first cell for communicating with the UE, a first indication that indicates updated system information that is associated with the second cell; and
means for communicating with the UE in the second cell using the updated system information.

### Supplementary Note 40

A first access network node that is configured to provide a first cell for communicating with a user equipment, UE, the first access network node comprising:
means for transmitting, in the first cell, first system information that is associated with a second cell that is not transmitting the first system information, wherein the second cell is provided by a second access network node;
means for receiving, from the second access network node, an indication of second system information that is associated with the second cell and that includes information corresponding to at least one of a public warning service or an emergency transmission; and
means for determining, based on the second system information, to transmit third system information associated with the first cell, using the first cell, wherein the third system information includes the information corresponding to the at least one of the public warning service or the emergency transmission.

### REFERENCE SIGNS LIST

1 communication system
3 user equipment
5 radio access network node
7 core network
9 associated cell
30 non-anchor NES cell
31 anchor NES cell
310 transceiver circuit
330 antenna
350 user interface
370 controller
390 memory
410 operating system
430 communications control module
510 transceiver circuit
530 antenna
550 core network interface
570 controller
590 memory
610 operating system
630 communications control module

What is claimed is:

1-34. (canceled)

35. A method performed by a mobile device, the method comprising:
receiving, in a first cell operated by an access network node, information used for requesting system information of a second cell configured to not transmit at least minimum system information;
transmitting, to another access network node configured to operate the second cell, a request for system information of the second cell in response to the receiving the information; and
receiving, from the another access network node in the second cell, at least a portion of the system information.

36. The method according to claim 35, wherein
the first cell is an anchor cell of the second cell, and
the second cell is a network energy saving cell.

37. The method according to claim 35, wherein
the request includes information indicating the second cell.

38. The method according to claim 35, wherein
the request includes information indicating the system information that is requested.

39. The method according to claim 38, wherein
the request includes a bitmap, and each bit of the bitmap represents a type of the system information that is requested.

40. The method according to claim 35, wherein
the request is transmitted in a message 1 (msg1) or a message 3 (msg3).

41. The method according to claim 35, further comprising:
receiving, from the access network node in the first cell, at least another portion of the system information.

42. The method according to claim 35, further comprising:
receiving, from the access network node in the first cell, second information indicating that system information of the second cell has been updated; and
receiving the updated system information of the second cell, in the first cell.

43. The method according to claim 42, wherein
the second information includes third information of a type of system information of the second cell that has been updated.

44. The method according to claim 35, further comprising:
receiving, from the access network node in the first cell, third system information of the first cell,
wherein the third system information includes at least one of:
system information corresponding to at least one of the public warning service or the emergency transmission, of the second cell, or
system information corresponding to the at least one of the public warning service or the emergency transmission, of the first cell.

45. The method according to claim 35, further comprising:
receiving information of at least one of:
information of one or more beams for use by the mobile device to receive the at least the portion of the system information; or
information of one or more transmission and reception points (TRPs) for use by the mobile device to receive the at least the portion of the system information.

46. The method according to claim 35, wherein
the request includes a random access preamble or a system information request in a radio resource control (RRC) message.

47. A method performed by an access network node, the method comprising:
transmitting, in a first cell operated by the access network node, information used for requesting system information of a second cell configured to not transmit at least minimum system information, and
wherein a request for the system information of the second cell is transmitted from the mobile device to another access network node configured to operate the second cell, in response to the transmitting the information, and
at least a portion of the system information is transmitted in the second cell to the mobile device.

48. A mobile device, comprising:
at least one memory storing instructions; and
at least one processor configured to process the instructions to:
receive, in a first cell operated by an access network node, information used for requesting system information of a second cell configured to not transmit at least minimum system information;
transmit, to another access network node configured to operate the second cell, a request for system information of the second cell in response to the receiving the information; and
receive, from the another access network node in the second cell, at least a portion of the system information.

49. An access network node comprising:
at least one memory storing instructions; and
at least one processor configured to process the instructions to:
transmit, in a first cell operated by the access network node, information used for requesting system information of a second cell configured to not transmit at least minimum system information, and
wherein a request for the system information of the second cell is transmitted from the mobile device to another access network node configured to operate the second cell, in response to the transmitting the information, and
at least a portion of the system information is transmitted in the second cell to the mobile device.
